(19) United States
(12) Patent Application Publication
(10) Pub. No.: US 2019/0370874 A1
(43) Pub. Date: Dec. 5, 2019

(54) SYSTEMS AND METHODS FOR PRESENTING MERCHANDISE TO CUSTOMERS ATTENDING AN EVENT AT A SHOPPING FACILITY

(71) Applicant: Walmart Apollo, LLC, Bentonville, AR (US)

(72) Inventors: Cristy C. Brooks, Cassville, MO (US); David Blair Brightwell, Bella Vista, AR (US); Greg A. Bryan, Centerton, AR (US); Bruce W. Wilkinson, Rogers, AR (US); David G. Tovey, Rogers, AR (US); David C. Winkle, Bella Vista, AR (US)

(21) Appl. No.: 16/424,171

(22) Filed: May 28, 2019

Related U.S. Application Data
(60) Provisional application No. 62/679,214, filed on Jun. 1, 2018.

(51) Int. Cl. G06Q 30/06; B65G 1/137

(52) U.S. Cl. CPC G06Q 30/0621; G06N 20/00; B65G 1/1373; G06Q 30/0641

(57) ABSTRACT

There are provided systems and methods for presenting merchandise to customers at a shopping facility. In one form, the system includes: a shopping facility hosting an event for customers; merchandise items related to the event; an automated storage and retrieval system that includes a merchandise holding area at the shopping facility for the merchandise items related to the event and a robot for moving between the holding area and the hosting area; and customer characteristics or preferences of customers attending the event. In the system, a control circuit identifies and selects the merchandise items related to the event, instructs stocking of the merchandise holding area with these merchandise items, identifies and selects a subset of merchandise items based on the customer characteristics or preferences, instructs the robot to gather the subset of merchandise items from the merchandise holding area and to deliver the subset to the hosting area.

### CROSS-REFERENCE TO RELATED APPLICATION

This application claims the benefit of U.S. Provisional Application No. 62/679,214, filed Jun. 1, 2018, which is incorporated by reference in its entirety herein.

### TECHNICAL FIELD

This invention relates generally to presenting merchandise to customers, and more particularly, to presenting merchandise to customers based on the customers' characteristics or preferences.

### BACKGROUND

In the retail setting, events are often held at shopping facilities that are of interest to customers. For example, these events may be educational, entertainment, or experiential events, such as, without limitation, events relating to cooking demonstrations, sporting related events, camping, fishing, home improvement projects, art, music, and clothing fashion. These events present customers with the opportunity to attend an event of interest to them and also present the shopping facilities with the opportunity to present event-related merchandise that may be of interest to the customers.

Accordingly, it is desirable to develop an approach where interesting events can be held at shopping facilities while presenting merchandise at the event that may be of interest to the customers. Under this approach, given the customers' interest in the event, it is desirable to present merchandise related to the event. However, it is not desirable to inundate customers with all possible event-related merchandise, some of which may not be of interest to the customers. Instead, it is desirable to present the customers with event-related merchandise that is more targeted to the customers' characteristics and preferences to increase the likelihood that the merchandise is of interest to the customers.

### BRIEF DESCRIPTION OF THE DRAWINGS

Disclosed herein are embodiments of systems, apparatuses and methods pertaining to the presentation of merchandise to customers attending an event at a shopping facility. This description includes drawings, wherein:

FIG. 1 is a schematic diagram in accordance with some embodiments;

FIG. 2 is a schematic diagram in accordance with some embodiments;

FIG. 3 is a schematic diagram in accordance with some embodiments;

FIG. 4 is a block diagram in accordance with some embodiments;

FIG. 5 is a block diagram in accordance with some embodiments;

FIG. 6 is a flow diagram in accordance with some embodiments;

FIG. 7 comprises a flow diagram as configured in accordance with various embodiments of these teachings;

FIG. 8 comprises a flow diagram as configured in accordance with various embodiments of these teachings;

FIG. 9 comprises a graphic representation as configured in accordance with various embodiments of these teachings;

FIG. 10 comprises a graph as configured in accordance with various embodiments of these teachings;

FIG. 11 comprises a flow diagram as configured in accordance with various embodiments of these teachings;

FIG. 12 comprises a graphic representation as configured in accordance with various embodiments of these teachings;

FIG. 13 comprises a graphic representation as configured in accordance with various embodiments of these teachings;

FIG. 14 comprises a graphic representation as configured in accordance with various embodiments of these teachings;

FIG. 15 comprises a flow diagram as configured in accordance with various embodiments of these teachings;

FIG. 16 comprises a flow diagram as configured in accordance with various embodiments of these teachings;

FIG. 17 comprises a graphic representation as configured in accordance with various embodiments of these teachings;

FIG. 18 comprises a graphic representation as configured in accordance with various embodiments of these teachings;

FIG. 19 comprises a block diagram as configured in accordance with various embodiments of these teachings;

FIG. 20 comprises a flow diagram as configured in accordance with various embodiments of these teachings;

FIG. 21 comprises a graph as configured in accordance with various embodiments of these teachings;

FIG. 22 comprises a flow diagram as configured in accordance with various embodiments of these teachings; and

FIG. 23 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for presenting merchandise that is likely to be of interest to customers attending an event at a shopping facility. In one form, the system comprises: a shopping facility hosting an educational, entertainment, or experiential event and including a predetermined hosting area for customers attending the event; a plurality of merchandise items related to the educational, entertainment, or experiential event; an automated storage and retrieval system comprising: a merchandise holding area at the shopping facility for holding the plurality of merchandise items related to the educational, entertainment, or experiential event and at least one robot configured to move between the merchandise holding area and the predetermined hosting area; and customer characteristics or preferences of at least one of the customers attending the educational, entertainment, or experiential event. The system further comprises: a control circuit operatively coupled to the automated storage and retrieval system, the control circuit configured to: identify and select the plurality of merchandise items related to the educational, entertainment, or experiential event, the plurality of merchandise items constituting a first subset of all merchandise items available for purchase; instruct stocking of the merchandise holding area with the first subset of merchandise items related to the educational, entertainment, or experiential event; identify and select a second subset of merchandise items from the first subset of merchandise items based on the customer characteristics or preferences; and instruct the at least one robot to gather the second subset of merchandise items from the merchandise holding area and to deliver the second subset to the predetermined hosting area.

In some implementations, the educational, entertainment, or experiential event comprises one or more of events relating to cooking demonstrations, sporting related events, camping, fishing, home improvement projects, art, music, and clothing fashion. In some implementations, the predetermined hosting area provides access to one or more of games, video monitors, entertainment and leisure activities, food and beverages, relaxing environmental ambience, and chairs and other lounge items to facilitate the comfort of customers. In some implementations, the merchandise holding area comprises: one or more rooms with a plurality of compartments of various sizes with each compartment large enough to hold to one or more of the first subset of merchandise items, each compartment being configured to be accessible by the at least one robot to retrieve merchandise items therein. In some implementations, the at least one robot is an autonomous ground vehicle (AGV) comprising: a locomotion system configured to facilitate movement of the AGV between the predetermined hosting area and the merchandise holding area; at least one obstacle detection sensor configured to detect obstacles in a direction of travel of the AGV; a navigational system configured to guide movement of the AGV and avoid obstacles; a merchandise retrieval mechanism configured to retrieve the second subset of merchandise items from the merchandise holding area; and an AGV control circuit operatively coupled to the locomotion system, the at least one obstacle detection sensor, the navigational system, and the merchandise retrieval mechanism, the AGV control circuit configured to operate and move the AGV and to retrieve and deliver merchandise. In some implementations, the system further comprises: a customer database containing at least one of demographic information of the at least one customer, shopping history of the at least one customer, and responses to a questionnaire or a shopping list completed by the at least one customer; wherein the customer characteristics or preferences are at least one of demographic information, the shopping history, and the responses to the questionnaire or the shopping list. In some implementations, the control circuit is configured to: access partiality information for the at least one customer and to use that partiality information to form corresponding partiality vectors for the at least one customer wherein the partiality vector has a magnitude that corresponds to a magnitude of the customer's belief in an amount of good that comes from an order associated with that partiality. In some implementations, the control circuit is further configured to: form counterpart candidate item vectors for each of the first subset of merchandise items wherein the counterpart vectors have a magnitude that represents the degree to which each of the candidate items pursues a corresponding partiality. In some implementations, the control circuit is further configured to: use the partiality vectors and the candidate item vectors to identify the second subset of merchandise items that accord with a given customer's own partialities. In some implementations, the control circuit is further configured to schedule the educational, entertainment, or experiential event at the shopping facility. In some implementations, the system further comprises: a communication interface at the predetermined hosting area configured to transmit input from the at least one customer regarding customer characteristics or preferences.

In another form, there is provided a method for presenting merchandise to customers at a shopping facility, the method comprising: hosting an educational, entertainment, or experiential event at a shopping facility and including a predetermined hosting area for customers attending the event; providing a plurality of merchandise items related to the educational, entertainment, or experiential event; holding the plurality of merchandise items related to the educational, entertainment, or experiential event in a merchandise holding area; and by at least one robot, moving between the merchandise holding area and the predetermined hosting area. The method further comprises, by a control circuit: identifying and selecting the plurality of merchandise items related to the educational, entertainment, or experiential event, the plurality of merchandise items constituting a first subset of all merchandise items available for purchase; instructing stocking of the merchandise holding area with the first subset of merchandise items related to the educational, entertainment, or experiential event; identifying and selecting a second subset of merchandise items from the first subset of merchandise items based on customer characteristics or preferences of at least one of the customers attending the educational, entertainment, or experiential event; and instructing the at least one robot to gather the second subset of merchandise items from the merchandise holding area and to deliver the second subset to the predetermined hosting area.

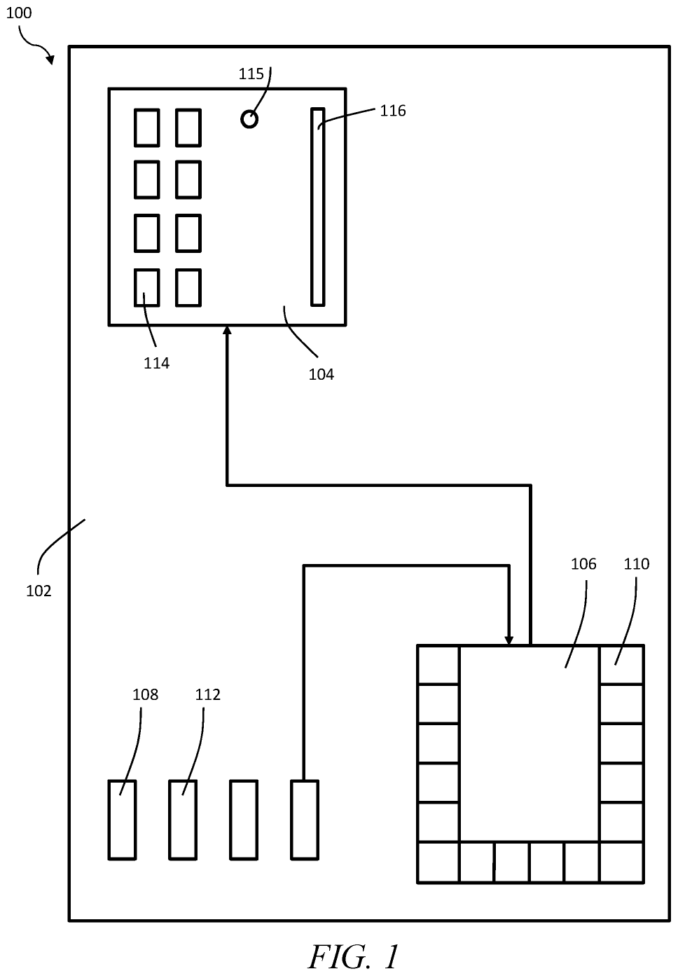

Referring to FIG. 1, there is shown a schematic diagram of a system 100 for presenting merchandise to customers at a shopping facility 102. In the system 100, it is contemplated that the shopping facility 102 will host a pre-planned event at a hosting area 104 at the shopping facility 102. It is further contemplated that the shopping facility 102 stocks a merchandise holding area 106 with merchandise relating to the event in advance of the event. An automated storage and retrieval system 108 transports selected merchandise from the merchandise holding area 106 to customers at the hosting area 104 for consideration by the customers. In addition, it is contemplated that the merchandise selected for presentation will be tailored to the customers' characteristics or preferences in order to improve the likelihood that the selected merchandise will be of interest to the customers.

The system 100 includes a shopping facility 102 that hosts an educational, entertainment, or experiential event. It is generally contemplated that any of a variety of events may be held at the shopping facility 102. For example, the educational, entertainment, or experiential event may include, without limitation, events relating to cooking demonstrations, sporting related events, camping, fishing, home improvement projects, art, music, and clothing fashion. As is evident, any the educational, entertainment, or experiential event may be arranged and planned at the shopping facility 102 that may be expected to generate a reasonable amount of interest and attendance by customers.

The shopping facility 102 further includes a predetermined hosting area 104 for customers attending the event that may include a variety of possible physical characteristics. It is generally contemplated that the hosting area 104 will be customized to the particular nature of the event being held. For example, if the event is a cooking demonstration, the hosting area 104 may include cooking utensils and cooking ingredients needed for the demonstration, as well as a seating area for customers attending the event. As another example, FIG. 1 shows seats 114 for customers arranged to view a screen 116 where a movie or some other visual information may be presented. It is generally contemplated that the predetermined hosting area 104 may be arranged with the comfort of customers in mind. For example, the hosting area 104 may include, without limitation, games (such as for children), video monitors, entertainment and leisure activities, food and beverages, a relaxing environmental ambience, and chairs and other lounge items to facilitate the comfort of customers. In other words, in one form, the hosting area 104 may be a shopping lounge in which retail products are presented to customer(s). The shopping lounge would be arranged for the comfort of shoppers and may include children's games, video monitors, and chairs for customers to sit in comfortably.

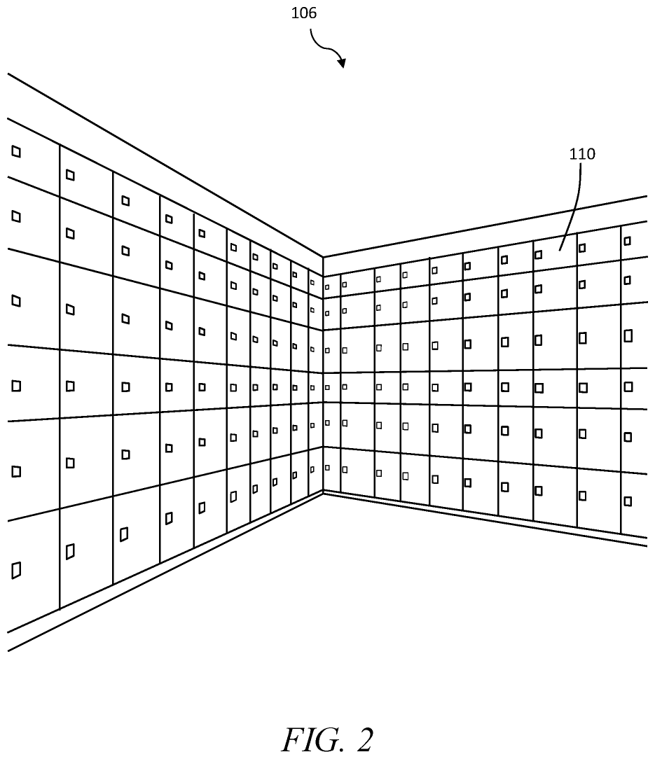

The system 100 also has an automated storage and retrieval system 108. It is contemplated that the automated storage and retrieval system 108 includes the merchandise holding area 106 for holding the plurality of merchandise items related to the educational, entertainment, or experiential event. The merchandise holding area 106 may be any of various different shapes, sizes, and physical characteristics. For example, in one form, the merchandise holding area 106 may comprise one or more rooms with several compartments of various sizes with each compartment large enough to hold the merchandise items related to the event. In this form, as can be seen in FIG. 2, the merchandise holding area 106 may be a room with a number of compartments 110 at different heights and locations, like safety deposit boxes. In one form, the compartments 110 or containers may be transparent, so as to allow customers to conduct a portion of their review process visually. There may be items the customer could reject based on viewing through the transparent container. Customer viewing may be facilitated by a communication interface 115 in the hosting area 104. Again, in one form, it is contemplated that this merchandise holding area 106 may be pre-stocked with specific merchandise items related to the event (a first subset of merchandise items) in advance of the event. For example, if the event relates to roofing, the merchandise may include roofing hammers and other roofing tools (and not all types of hammers and tools).

The automated storage and retrieval system 108 may include robot(s) 112 configured to move between the merchandise holding area 106 and the predetermined hosting area 104. In one form, each compartment 110 in the holding area 106 is configured to be accessible by the robot(s) 112 to retrieve merchandise items therein. It is generally contemplated that these robot(s) 112 may be any of various types. For example, in one form, there may be a system of robots that transport racks, shelving units, or mobile modular displays containing the products for which the customer(s) have expressed interest (as well as additional merchandise, such as complimentary, roll-back, or impulse buy items). In one form, the racks, shelving units, or mobile modular displays may be configured to cooperate with the structure of the robots (or transport vehicles) so that they can be interchanged quickly via some sort of plug-in set-up with the robots. Further, in one form, it is contemplated that the robot(s) 112 may be in the form of autonomous ground vehicles (AGVs) that can travel back and forth between the merchandise holding area 106 and the hosting area 104 with little (if any) assistance from a human operator.

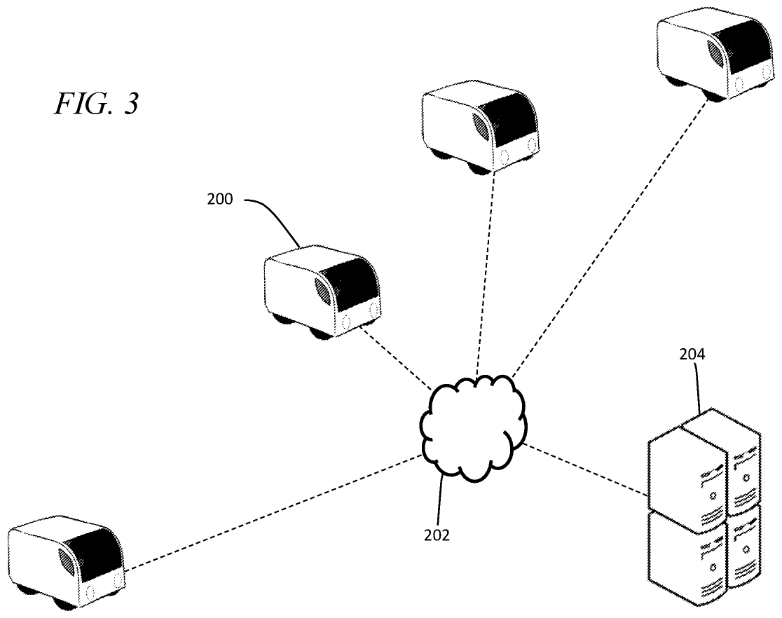

Referring to FIG. 3, there is shown an example in which multiple AGVs 200 move about the shopping facility 102 and operate autonomously. It is generally contemplated that the multiple AGVs 200 may travel back and forth between the merchandise holding area 106 and the hosting area 104 at the shopping facility 102. Under this approach, to facilitate coordination of the AGVs 200 in transporting different merchandise, the AGVs 200 may communicate over a network 202. The system 100 may include a central computer system 204 at the shopping facility 102 accessible by one or more of the AGVs 200 over the network 202.

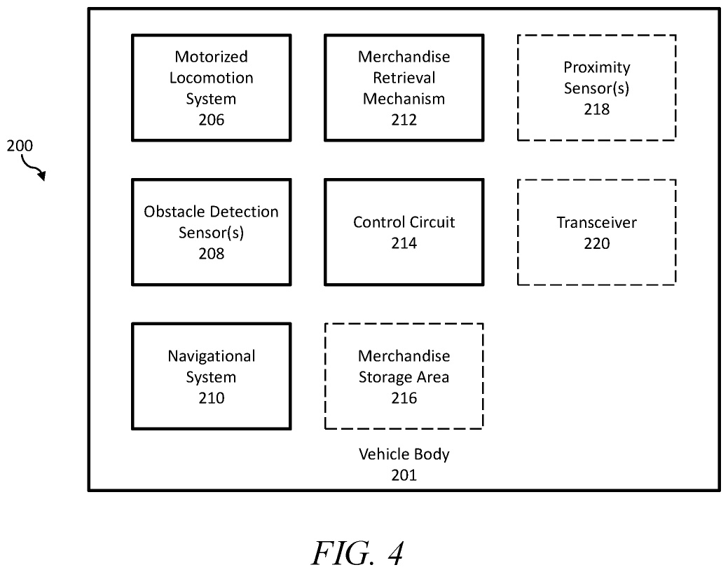

Referring now to FIG. 4, it is generally contemplated that the AGV 200 includes certain components in and about its vehicle body 201 that allow it to convey merchandise and to travel about the shopping facility 102. In one form, the AGV 200 includes a motorized locomotion system 206, at least one obstacle detection sensor 208, a navigational system 210, a merchandise retrieval mechanism 212, and an AGV control circuit 214. It is contemplated that the AGV 200 may also include other components, such as, without limitation, a merchandise storage area 216, proximity sensor(s) 218, and a transceiver 220. It is generally contemplated that the AGVs 200 are generally interchangeable with one another.

The AGV 200 includes a motorized locomotion system 206 configured to facilitate movement of the AGV 200, especially between the merchandise holding area 106 and the hosting area 104. It is generally contemplated that the motorized locomotion system 206 may include wheels (or tracks or legs), a motor, and a drive mechanism. For example, in one preferred form, the motorized locomotion system 206 of each AGV 200 includes two sets of wheels. The AGVs 200 also each include a power source (such as a battery or solar cell) configured to energize movement and operation of the AGV 200, i.e., to energize the AGV's motorized locomotion system 206 and other components. The motorized locomotion system 206 may comprise one or more motors that control one or more of a speed, direction, and/or orientation of one or more wheels (or tracks or legs) on the AGV 200. The motorized locomotion system 206 may be configured to be controlled by the control circuit 214 to move the AGV 200 in designated directions.

The AGV 200 also includes sensor(s) 208 configured to detect obstacles in a direction of travel of the AGV 200 and to stop the AGV 200 if obstacles are detected. For example, some types of obstacle detection sensors may include laser, ultrasound, optical, and infrared sensors, although any suitable obstacle detection sensor may be used. Further, some examples of types of obstacles the AGV 200 may encounter at the shopping facility 102 include walls, shopping carts, other AGVs 200, people, and other sorts of obstructions, but these examples are not intended to encompass an exhaustive list of possible obstacles.

The AGV 200 includes a navigational system 210 for guiding movement of the AGV 200 at and around the shopping facility 102. The navigational system 210 includes sensor(s) for navigation and may be considered to include the sensor(s) 208 for detecting obstacles in the AGV's path as it travels along its route (as well as proximity sensor(s) 218). The navigational sensor(s) may be of any of various types, including GPS, compasses and other navigational aids, gyroscopes, magnetometers, accelerometers, radar laser range finders, ultrasound range finders, infrared sensors, and optical/imaging sensors (such as video/camera devices).

The navigational system 210 may use, in part, any of various known indoor positioning and navigational approaches to navigate in the store environment. For example, the navigational system 210 may use, alone or in combination, GPS, WiFi Indoor Positioning System (WIPS), Ultra-Wideband (UWB), Radio Frequency Identification (RFID) and visual cues. In one form, these approaches may use GPS to assist autonomous vehicles in navigation through store environments and may also employ the use of WIPS, UWB, RFID, and visual cues, in an effort to facilitate a multi-layered approach to navigation within indoor store environments. WIPS utilizes internet connectivity to provide navigation based on tracking location sent to and from the network. Ultra-Wideband (UWB) technologies use radio waves capable of penetrating all objects, which are received by beacons or sensors. RFID tagging may also be used to provide an additional layer of navigation for autonomous technologies by being affixed to pipes, walls, shelving units, etc. The autonomous vehicles may have RFID sensors that will be able to read RFID tags, which will provide information on location. The autonomous vehicles may also have visual sensors that will allow them to navigate through the store environment by way of visual cues and visually identified objects.

The AGV 200 includes a merchandise retrieval mechanism 212 configured to retrieve merchandise items from the merchandise holding area 106. For example, the merchandise retrieval mechanism may be in the form of an arm or gripper mechanism configured to open compartments 110 in the merchandise holding area 106 and remove merchandise items from the compartments 110. This arm or gripper mechanism may be any of various types, such as grabber claws, magnetic devices, etc., as may be suitable to retrieve merchandise items and transport them to the hosting area 104. The AGV 200 may use proximity sensor(s) 218 to assist with retrieval by providing information regarding distance from the merchandise items being retrieved. In one form, it is contemplated, that the merchandise retrieval mechanism 212 may include trays upon which several merchandise items may be stacked or arranged for transport to the hosting area 104. In another form, it is contemplated that store associates may assist with the stacking, arrangement, or loading of the AGV 200 with merchandise items at the holding area 106.

The AGV 200 may include a merchandise storage area 216, such as a storage compartment, that may be suited to carrying packages and/or other types of merchandise cargo. As should be evident, the storage area 216 may be any of various physical sizes and geometries. In one form, it is generally contemplated that the merchandise storage area 216 may be a storage compartment formed in the interior of the vehicle body 201 that may be removably covered by a lid of the compartment. It is generally contemplated that the AGV 200 may include a storage area 216 to facilitate transport of merchandise for consideration by customers at the hosting area 104.

In addition, the AGV 200 may include a transceiver 220 for wireless communication. In one form, for example, it is contemplated that the AGV 200 may communicate with a store server or central computer system 204. The transceiver 220 may, for example, comprise one or more of a WLAN transceiver, a WWAN transceiver, a mobile data network transceiver, a satellite network transceiver, a WiMax transceiver, a Wi-Fi transceiver, a Bluetooth transceiver, and the like.

Further, the AGV 200 includes a control circuit 214 operatively coupled to, at least, the motorized locomotion system 206 and navigational system 210. The AGV control circuit 214 is configured to operate and move the AGV 200. The AGV control circuit 214 may comprise a processor, a microprocessor, and the like and may be configured to execute computer-readable instructions stored on a computer-readable storage memory. The computer-readable storage memory may comprise volatile and/or non-volatile memory and have stored upon it a set of computer-readable instructions which, when executed by the AGV control circuit 214, cause the control circuit 214 to move and operate the AGV 200. The architectural options for such structures are well known and understood in the art and require no further description here. The AGV control circuit 214 is configured (for example, by using corresponding programming as will be well understood by those skilled in the art) to carry out one or more of the steps, actions, and/or functions described herein.

In some forms, it is contemplated that other delivery mechanisms may be used in addition to or in lieu of robots and AGVs. For example, a conveyor system may be arranged at the shopping facility 102 between the event hosting area 104 and the merchandise holding area 106. As additional examples, elevators and/or carousels may be used as part of the delivery mechanism between the event hosting area 104 and the merchandise holding area 106.

As addressed above, it is generally contemplated that merchandise is presented to customers at the hosting area 104 of the shopping facility 102. Further, the merchandise that is presented is targeted, or curated, so that it is likely to be of interest to the customers attending the event. First, the merchandise is pre-selected to be related to the event being hosted (which is likely to be of interest to customers who have chosen to attend the event). Second, the merchandise presented to the customer is further refined based on the specific customer characteristics or preferences of customers attending the event, as addressed further below. So, the system provides for an intelligent selection of merchandise to be presented to the customers.

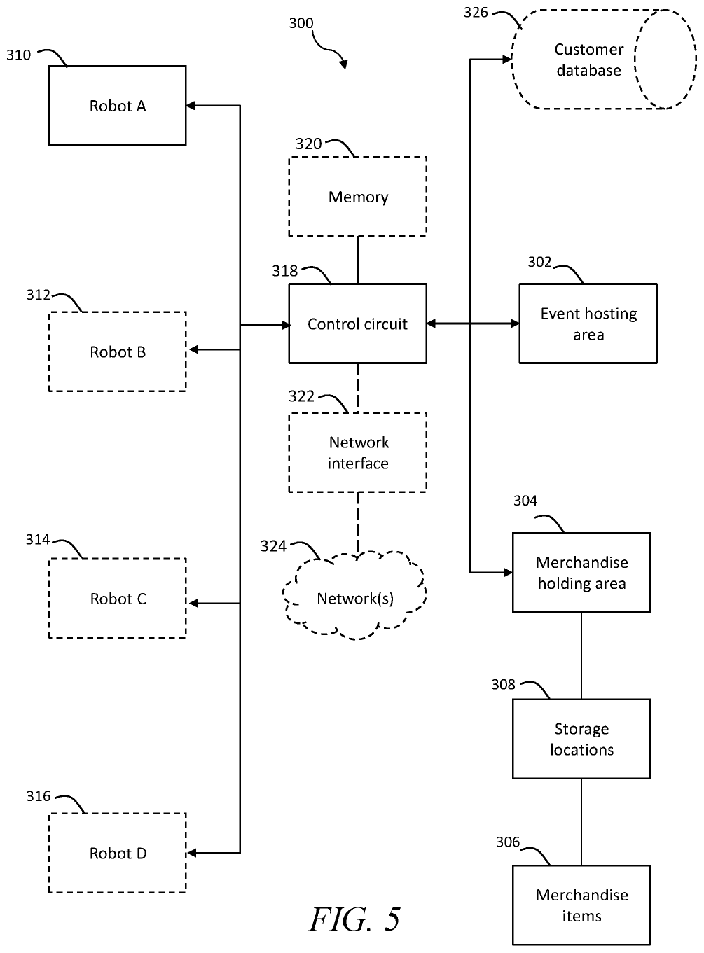

FIG. 5 shows one example of a system 300 showing various components and the potential interaction of various components of the system 300. As can be seen, in this example, the shopping facility includes an event hosting area 302 where customer attend some sort of event, such as described above. It further includes a merchandise holding area 304 where merchandise items 306 related to the event are stored. In this form, it is generally contemplated that the merchandise holding area 304 includes a number of storage locations 308, or compartments, where the merchandise items 306 may be held. Further, in this form, the system 300 may include one or more robots that transport merchandise items 306 from the merchandise holding area 304 to the event hosting area 302. In this particular example, there are four robots (Robot A (310), Robot B (312), Robot C (314), and Robot D (316), although, as is evident, various numbers and types of robots may be used.

As shown in FIG. 5, a control circuit 318 governs the operation of the system 300. The control circuit 318 may be in wireless communication with the robots 310, 312, 314, 316 and may control the selection, or curation, or merchandise items 306 from the merchandise holding area 304. As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 318 may be configured (for example, by using corresponding programming stored in a memory as will be well understood by those skilled in the art) to carry out one or more of the steps, actions, and/or functions described herein.

As shown in FIG. 5, the control circuit 318 is coupled to a memory 320 and may be coupled to a network interface 322 and network(s) 324. The memory 320 can, for example, store non-transitorily computer instructions that cause the control circuit 318 to operate as described herein, when the instructions are executed, as is well known in the art. Further, the network interface 322 may enable the control circuit 318 to communicate with other elements (both internal and external to the system 300). This network interface 322 is well understood in the art. The network interface 322 can communicatively couple the control circuit 318 to whatever network or networks 324 may be appropriate for the circumstances. The control circuit 318 may be in communication with the server of the shopping facility 102 and may make use of cloud databases and/or operate in conjunction with a cloud computing platform.

The control circuit 318 operates to cause the selection and transport of merchandise items 306 that are curated for, or likely to be of interest, to the customers. First, the control circuit 318 selects a first subset of merchandise items that are related to the event. In other words, the control circuit 318 identifies and selects the plurality of merchandise items 306 related to the educational, entertainment, or experiential event with the plurality of merchandise items 306 constituting a first subset of all merchandise items available for purchase. It then instructs stocking of the merchandise holding area 304 with the first subset of merchandise items related to the educational, entertainment, or experiential event.

Next, the control circuit 318 identifies and selects merchandise items related to the customers attending the event. In other words, the control circuit 318 identifies and selects a second subset of merchandise items from the first subset of merchandise items 306 based on the customer characteristics or preferences. It then instructs the robot(s) to gather the second subset of merchandise items from the merchandise holding area 304 and to deliver the second subset to the hosting area 302. In addition to the second subset, supplemental merchandise items may also be included for presentation (such as promotional, seasonal, or impulse merchandise, or accessories related to the second subset merchandise). It is generally contemplated that the control circuit 318 may coordinate these operations with the scheduling of the event at the shopping facility 102. In other words, the control circuit 318 may schedule the event to avoid any conflicts with other planned events and to allow sufficient time and resources for stocking the merchandise holding area 304.

In one form, it is contemplated that the control circuit 318 accesses a customer database 326. It is generally contemplated that this database 326 includes information about customers, including, if available, information about a customer's characteristics or preferences that may correlate to one or more different types of merchandise items 306. It is generally contemplated that customer may have different reasons for their preferences. The system 300 generally uses a customer-targeted approach, and the customer's preferences may be determined in several ways. In one form, the customer database 326 may be configured to receive express input from customer(s) regarding their preferences, such as via the use of questionnaires that may be circulated prior to the event. In another form, the system 300 may use demographic information or shopping history to determine products for the subset of merchandise items 306 to be presented to the customers. In other words, the customer database 326 may contain demographic information of the customer(s), shopping history of the customer(s), and responses to a questionnaire or a shopping list completed by the customer(s).

In another form, it is contemplated that the customer preferences may be determined based on the concept of “value vectors.” Under this approach, the control circuit 318 may be configured to: access partiality information for the customer(s) and to use that partiality information to form corresponding partiality vectors for the customer(s) wherein the partiality vector has a magnitude that corresponds to a magnitude of the customer's belief in an amount of good that comes from an order associated with that partiality. The control circuit 318 may be further configured to form counterpart candidate item vectors for each of the merchandise items 306 wherein the counterpart vectors have a magnitude that represents the degree to which each of the candidate items pursues a corresponding partiality. The control circuit 318 may be further configured to use the partiality vectors and the candidate item vectors to identify the subset of merchandise items to be presented to the customers that accord with a given customer's own partialities. Value vectors” are addressed in greater detail below.

It is also contemplated that there may be communication interfaces at one or both of the merchandise holding area 304 and event hosting area 302. The communication interfaces may be any of various forms, such as, without limitation, an intercom/audio interface or an audiovisual/video interface. For example, in one form, a communication interface 115 at the hosting area 302 may be configured to transmit input from the customers regarding customer characteristics or preferences that may be used to curate, or select, merchandise tailored to those customers. Further, customers may input/transmit supplemental information regarding products, such as a range of types, styles, sizes, etc. of products to be presented. Also, in one form, it is contemplated that the communication interface in the merchandise holding area 304 may allow customers to see and select merchandise in the holding area 304 that may be of interest to them.

These interfaces may be used in the presentation of products to the customers (in addition to the physical presentation of products to customers). For example, the interfaces may include (or be used in conjunction with) 3D/haptic/VR devices, and the curating and selection of products may be performed via the customers' use of and interaction with 3D/haptic/VR devices. These interfaces may be used to present visual representations, attributes, characteristics, and other information about the product (that may not be readily determinable from an examination of the product itself). In addition, these interfaces may be used to supplement the customers' selection when certain initially-presented merchandise may be unavailable or unappealing. For example, a customer could opt to buy something that is not immediately available via an “endless aisle” selection (that might supplement the available physical products).

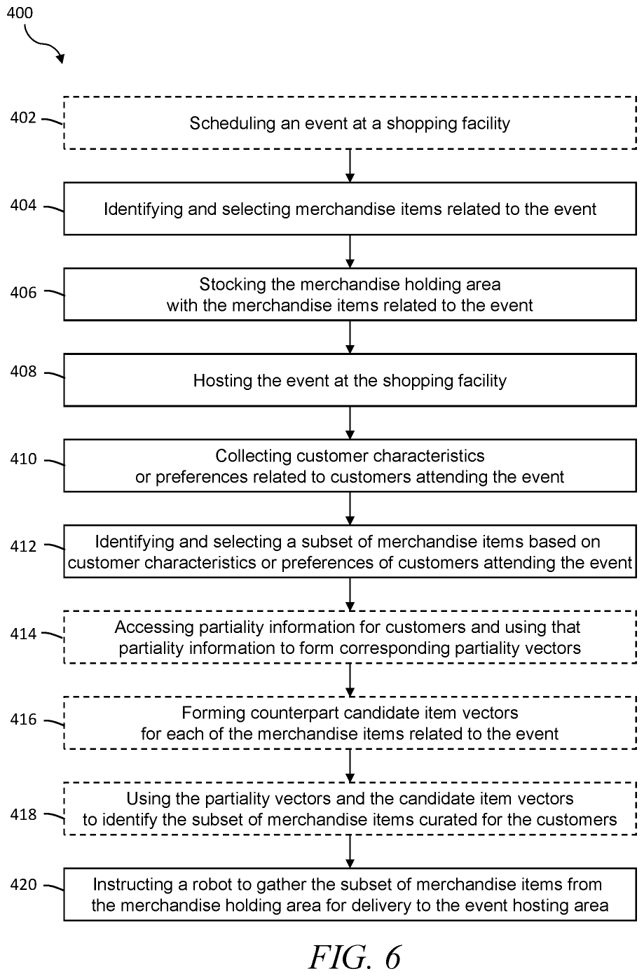

Referring to FIG. 6, there is shown a process 400 for presenting customers with curated, or targeted, merchandise items at a shopping facility. It is generally contemplated that the merchandise will be presented in conjunction with a pre-planned event being held at the shopping facility. The process 400 further includes use of an automated storage and retrieval system for holding merchandise relating to the event and transporting it from a merchandise holding area to the event hosting area. The process 400 may use the systems 100 and 300 and components thereof, as well as AGV 200.

As shown at block 402, an event may be initially scheduled at the shopping facility. As addressed above, it is generally contemplated that the event may be any of a variety of educational, entertainment, or experiential events that are deemed likely to be of interest to customers and to attract them to the shopping facility. At block 404, merchandise items relating to the event are identified and selected. This step represents the first curation step seeking to limit the universe of merchandise items to a subset that is likely to be of interest to customers attending the planned event.

At block 406, stocking of a merchandise holding area is instructed. The merchandise holding area is stocked with the subset of merchandise items related to the event. As addressed above, the merchandise holding area may be any of various types and may be arranged with merchandise in various ways. In one form, the merchandise holding area may be a room with multiple compartments for storage of the merchandise items related to the event. At block 408, following stocking of the merchandise area, the event is ready to be hosted at the shopping facility.

At block 410, customer characteristics or preferences are collected relating to customers attending the event. This collection may occur at various different points in time. For example, these customer characteristics or preferences may already be stored in a customer database prior to planning of the event (which may include, without limitation, customer shopping history or value vector information). As another example, these customer characteristics or preferences may be collected at the time of or shortly before the scheduled event time, such as, for example, by questionnaires completed by customers, shopping lists provided by customers, or direct input provided by customers at the hosting area. At block 412, based on these characteristics and preferences of customers attending the event, a further subset of merchandise items is identified and selected. This step represents the second curation step seeking to further limit the merchandise presented to customers to merchandise likely to be of interest to the customers. It should be understood, however, that this targeted merchandise may be supplemented with additional types of merchandise items.

Blocks 414 to 418 show the optional use of value vectors to identify and select merchandise items. At block 414, partiality vectors for customers are created corresponding to partiality information for the customers. It is generally contemplated that these partiality vectors for customers are created prior to the event and may be stored in a customer database. At block 416, counterpart candidate item vectors are created for the merchandise items related to the event. Again, in one form, these vectors are likely created prior to the planning and scheduling of the event. At block 418, the customer partiality vectors and the candidate item vectors are correlated to identify the subset of merchandise items to be presented to various customers.

At block 420, a robot is instructed to gather the subset of merchandise items to be presented to customers from the merchandise holding area and to transport this subset to the event hosting area. As addressed above, it is contemplated that any of various types of robots and autonomous ground vehicles may be used, including, without limitation, AGV 200 described above. A route from the merchandise holding area to the event hosting area (and back again) may be preprogrammed in the robots to facilitate the process 400.

As stated above, it is contemplated that the customer preferences may be determined based on the concept of “value vectors.” It is generally contemplated that the merchandise items to be presented may each have characteristics that correspond to certain customer-specific values, affinities, aspirations, and preferences. This approach generally seeks to match merchandise items with corresponding customer-specific values, affinities, aspirations, and preferences. “Value vectors” are described in more detail as follows.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

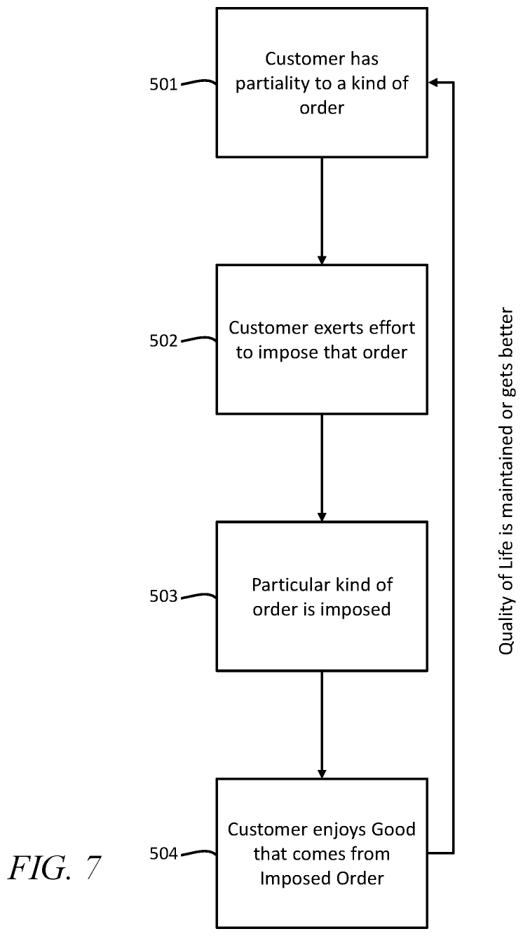

FIG. 7 provides a simple illustrative example in these regards. At block 501 it is understood that a particular person has a partiality (to a greater or lesser extent) to a particular kind of order. At block 502 that person willingly exerts effort to impose that order to thereby, at block 503, achieve an arrangement to which they are partial. And at block 504, this person appreciates the “good” that comes from successfully imposing the order to which they are partial, in effect establishing a positive feedback loop.

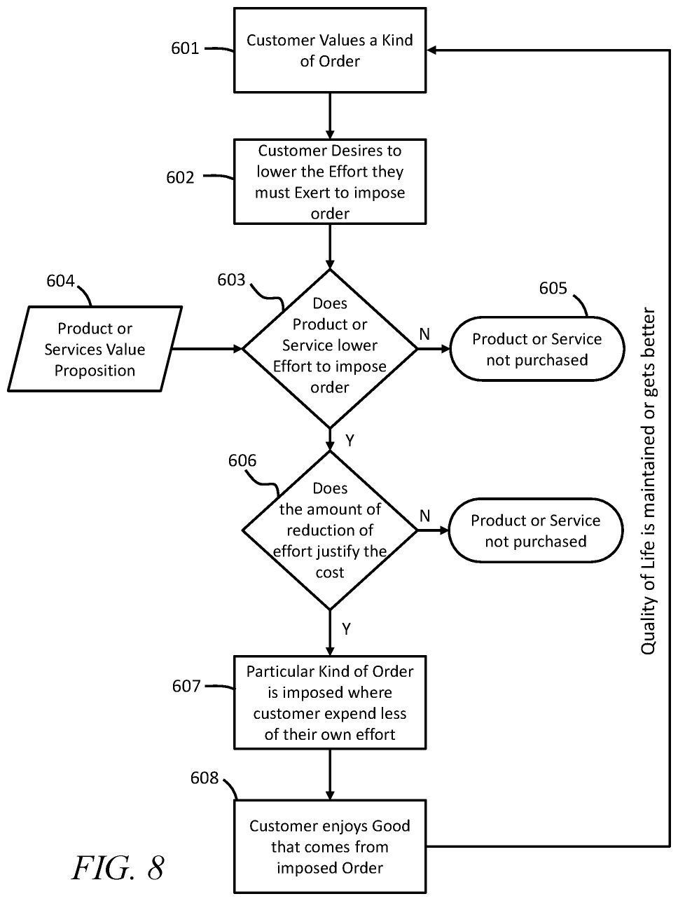

Understanding these partialities to particular kinds of order can be helpful to understanding how receptive a particular person may be to purchasing a given product or service. FIG. 8 provides a simple illustrative example in these regards. At block 601 it is understood that a particular person values a particular kind of order. At block 602 it is understood (or at least presumed) that this person wishes to lower the effort (or is at least receptive to lowering the effort) that they must personally exert to impose that order. At decision block 603 (and with access to information 604 regarding relevant products and or services) a determination can be made whether a particular product or service lowers the effort required by this person to impose the desired order. When such is not the case, it can be concluded that the person will not likely purchase such a product/service 605 (presuming better choices are available).

When the product or service does lower the effort required to impose the desired order, however, at block 606 a determination can be made as to whether the amount of the reduction of effort justifies the cost of purchasing and/or using the proffered product/service. If the cost does not justify the reduction of effort, it can again be concluded that the person will not likely purchase such a product/service 605. When the reduction of effort does justify the cost, however, this person may be presumed to want to purchase the product/service and thereby achieve the desired order (or at least an improvement with respect to that order) with less expenditure of their own personal effort (block 607) and thereby achieve, at block 608, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

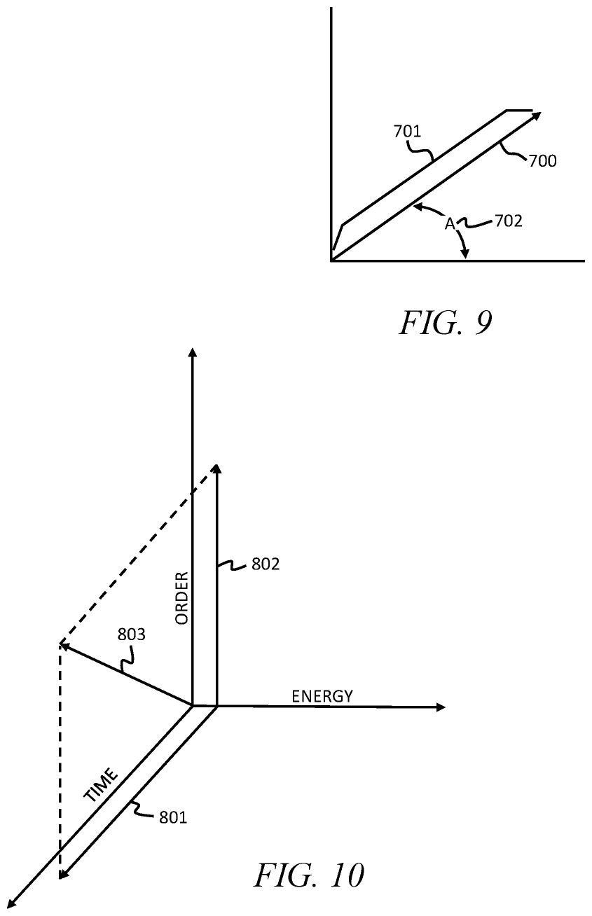

FIG. 9 provides some illustrative examples in these regards. By one approach the vector 700 has a corresponding magnitude 701 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 701, the greater the strength of that belief and vice versa. Per another example, the vector 700 has a corresponding angle A 702 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 10 presents a space graph that illustrates many of the foregoing points. A first vector 801 represents the time required to make such a wristwatch while a second vector 802 represents the order associated with such a device (in this case, that order essentially represents the skill of the craftsman). These two vectors 801 and 802 in turn sum to form a third vector 403 that constitutes a value vector for this wristwatch. This value vector 803, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

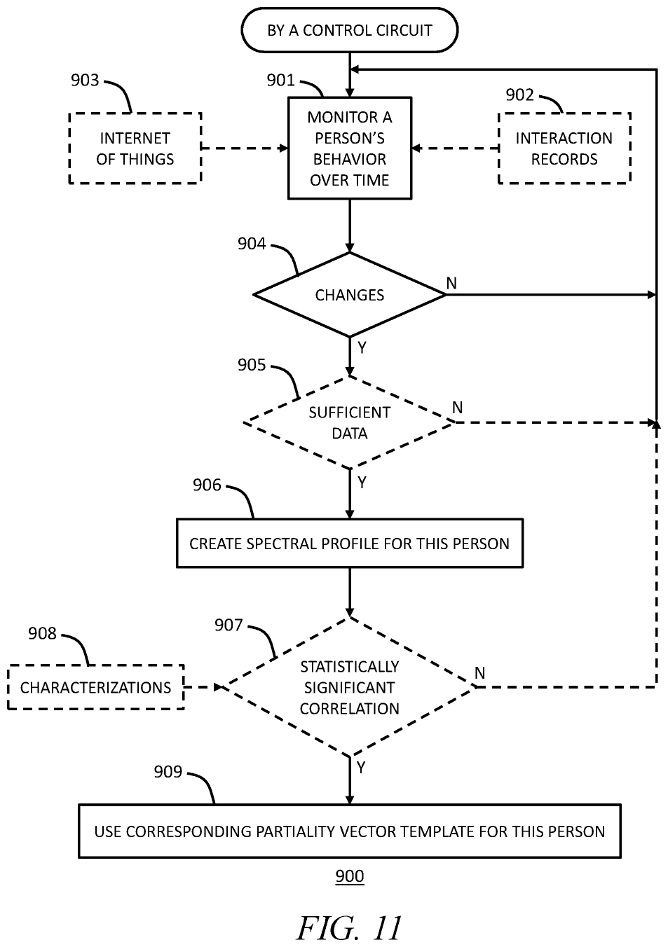

FIG. 11 presents a process 900 that illustrates yet another approach in these regards. For the sake of an illustrative example it will be presumed here that a control circuit of choice (with useful examples in these regards being presented further below) carries out one or more of the described steps/actions.

At block 901 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 902 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 902 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IoT) 903. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

In an exemplary embodiment, the localized IoT devices and controllers can perform most, if not all, of the computational load and associated monitoring, and then later, asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary as created under nominal conditions. In an exemplary embodiment, the kernel excludes relatively recent intermittent data (“KERRI”). As a result, in an exemplary embodiment, KERRI is a continuously utilized near term source of data, but KERRI may be discarded depending upon the degree to which such KERRI has any value. In an exemplary embodiment, KERRI may not even be utilized in any form if it is determined that KERRI is transient and may be considered as signal noise.

Depending upon what sensors a person encounters, information can be available regarding a person's travels, lifestyle, calorie expenditure over time, diet, habits, interests and affinities, choices and assumed risks, and so forth. This process 900 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 904 this process 900 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 905 this process 900 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

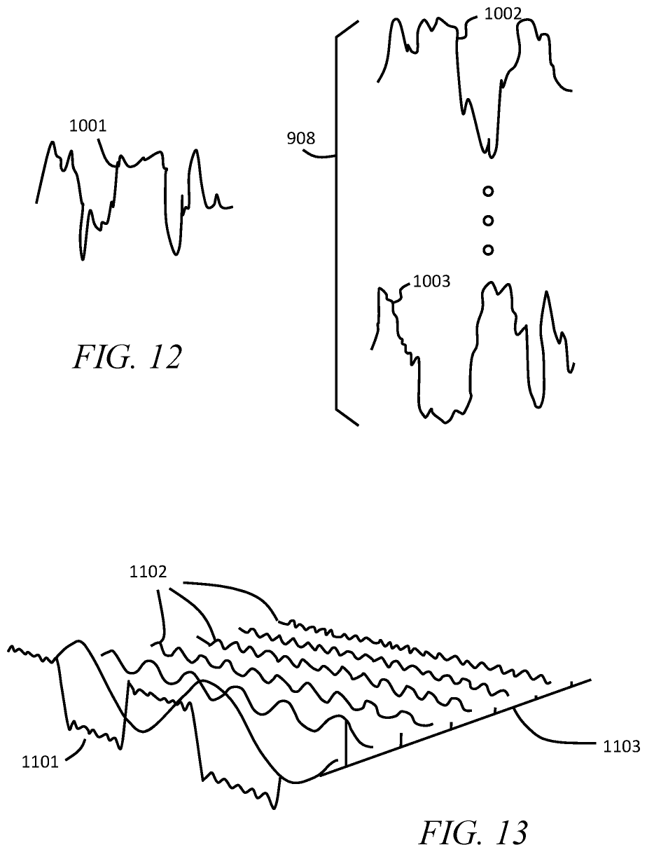

At block 907 this process 900 uses these detected changes to create a spectral profile for the monitored person. FIG. 12 provides an illustrative example in these regards with the spectral profile denoted by reference numeral 1001. In this illustrative example the spectral profile 1001 represents changes to the person's behavior over a given period of time (such as an hour, a day, a week, or some other temporal window of choice). Such a spectral profile can be as multidimensional as may suit the needs of a given application setting.

At optional block 907 this process 900 then provides for determining whether there is a statistically significant correlation between the aforementioned spectral profile and any of a plurality of like characterizations 908. The like characterizations 908 can comprise, for example, spectral profiles that represent an average of groupings of people who share many of the same (or all of the same) identified partialities. As a very simple illustrative example in these regards, a first such characterization 1002 might represent a composite view of a first group of people who have three similar partialities but a dissimilar fourth partiality while another of the characterizations 1003 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 908 are based and/or the amount of data and/or the duration of time over which data is available for the monitored person.

Referring now to FIG. 13, by one approach the selected characterization (denoted by reference numeral 1101 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 1101 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 13 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 13) in the same sense as, for example, a radio or acoustic wave, it will nevertheless be understood that such a behavioral characterization 1101 can itself be broken down into a plurality of sub-waves 1102 that, when summed together, equal or at least approximate to some satisfactory degree the behavioral characterization 1101 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 1103 wherein the X axis represents frequency and the Y axis represents the magnitude of the response of the monitored person at each frequency/sub-wave of interest.

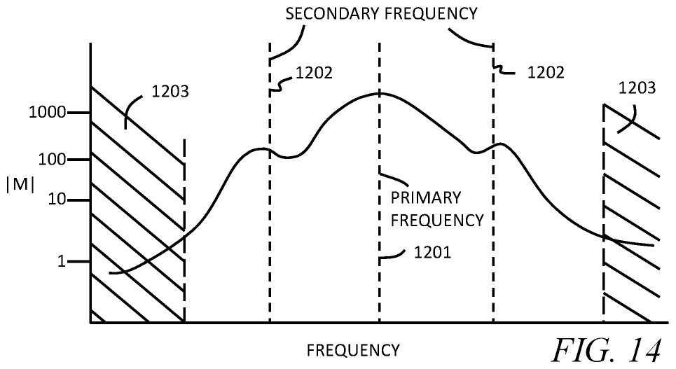

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 14, for many people the spectral profile of the individual person will exhibit a primary frequency 1201 for which the greatest response (perhaps many orders of magnitude greater than other evident frequencies) to life is exhibited and apparent. In addition, the spectral profile may also possibly identify one or more secondary frequencies 1202 above and/or below that primary frequency 1201. (It may be useful in many application settings to filter out more distant frequencies 1203 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 1101, those partialities can be used as an initial template for a person whose own behaviors permit the selection of that particular characterization 1101. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

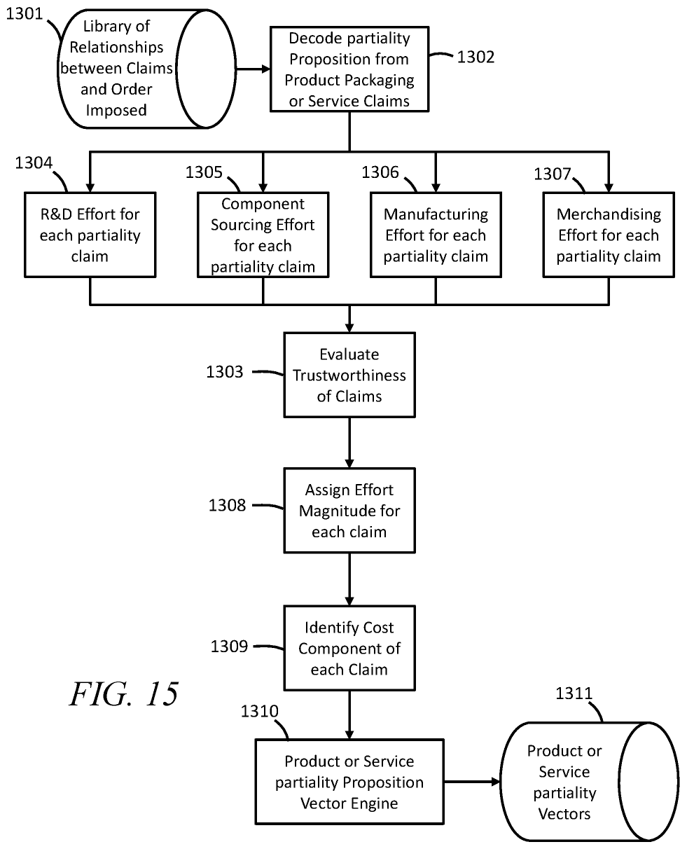

FIG. 15 presents one non-limiting illustrative example in these regards. The illustrated process presumes the availability of a library 1301 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 1302 this process provides for decoding one or more partiality propositions from specific product packaging (or service claims). For example, the particular textual/graphics-based claims presented on the packaging of a given product can be used to access the aforementioned library 1301 to identify one or more corresponding imposed orders from which one or more corresponding partialities can then be identified.

At block 1303 this process provides for evaluating the trustworthiness of the aforementioned claims. This evaluation can be based upon any one or more of a variety of data points as desired. FIG. 15 illustrates four significant possibilities in these regards. For example, at block 1304 an actual or estimated research and development effort can be quantified for each claim pertaining to a partiality. At block 1305 an actual or estimated component sourcing effort for the product in question can be quantified for each claim pertaining to a partiality. At block 1306 an actual or estimated manufacturing effort for the product in question can be quantified for each claim pertaining to a partiality. And at block 1307 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 1308 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 1309 this process provides for identifying a cost component of each claim, this cost component representing a monetary value. At block 1310 this process can use the foregoing information with a product/service partiality propositions vector engine to generate a library 1311 of one or more corresponding partiality vectors for the processed products/services. Such a library can then be used as described herein in conjunction with partiality vector information for various persons to identify, for example, products/services that are well aligned with the partialities of specific individuals.

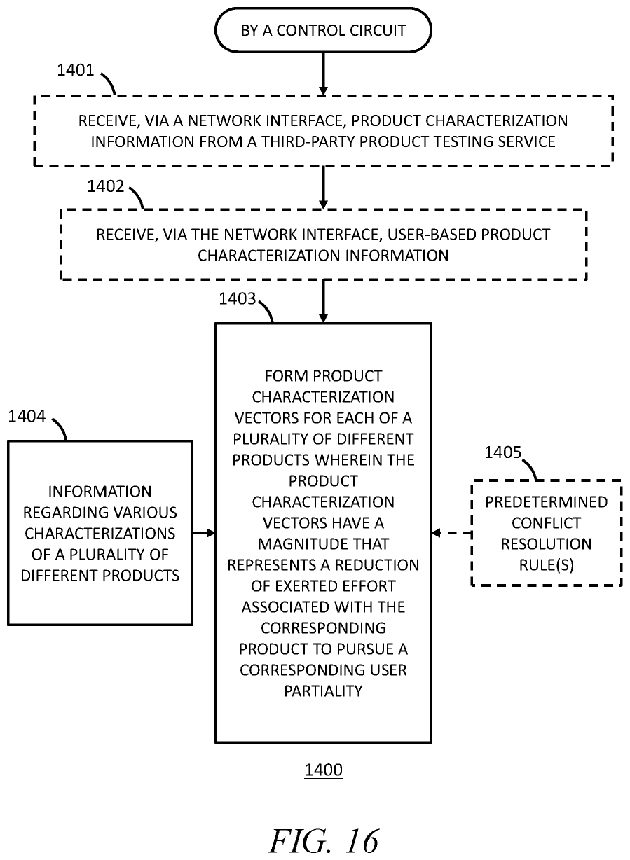

FIG. 16 provides another illustrative example in these same regards and may be employed in lieu of the foregoing or in total or partial combination therewith. Generally speaking, this process 1400 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 16, this process 1400 can be carried out by a control circuit of choice. Specific examples of control circuits are provided elsewhere herein.

As described further herein in detail, this process 1400 makes use of information regarding various characterizations of a plurality of different products. These teachings are highly flexible in practice and will accommodate a wide variety of possible information sources and types of information. By one optional approach, and as shown at optional block 1401, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1402, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1400 provides for accessing (see block 1404) information regarding various characterizations of each of a plurality of different products. This information 1404 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1404 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1403 the control circuit uses the foregoing information 1404 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1404. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1405 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1404 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

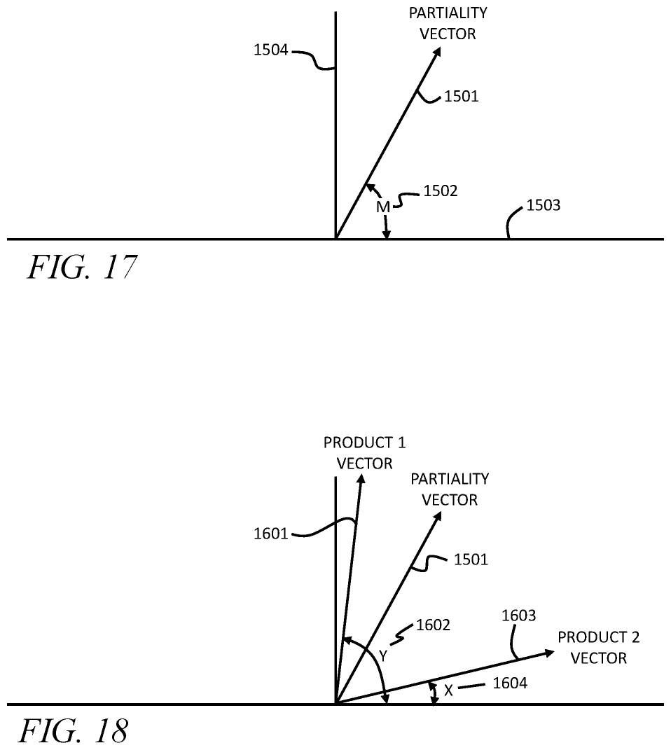

As noted above, the magnitude corresponding to a particular partiality vector for a particular person can be expressed by the angle of that partiality vector. FIG. 17 provides an illustrative example in these regards. In this example the partiality vector 1501 has an angle M 1502 (and where the range of available positive magnitudes range from a minimal magnitude represented by 0° (as denoted by reference numeral 1503) to a maximum magnitude represented by 90° (as denoted by reference numeral 1504)). Accordingly, the person to whom this partiality vector 1501 pertains has a relatively strong (but not absolute) belief in an amount of good that comes from an order associated with that partiality.

FIG. 18, in turn, presents that partiality vector 1501 in context with the product characterization vectors 1601 and 1603 for a first product and a second product, respectively. In this example the product characterization vector 1601 for the first product has an angle Y 1602 that is greater than the angle M 1502 for the aforementioned partiality vector 1501 by a relatively small amount while the product characterization vector 1603 for the second product has an angle X 1604 that is considerably smaller than the angle M 1502 for the partiality vector 1501.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1601 with the partiality vector 1501 will be larger than the resultant scaler value for the vector dot product of the product 2 vector 1603 with the partiality vector 1501. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

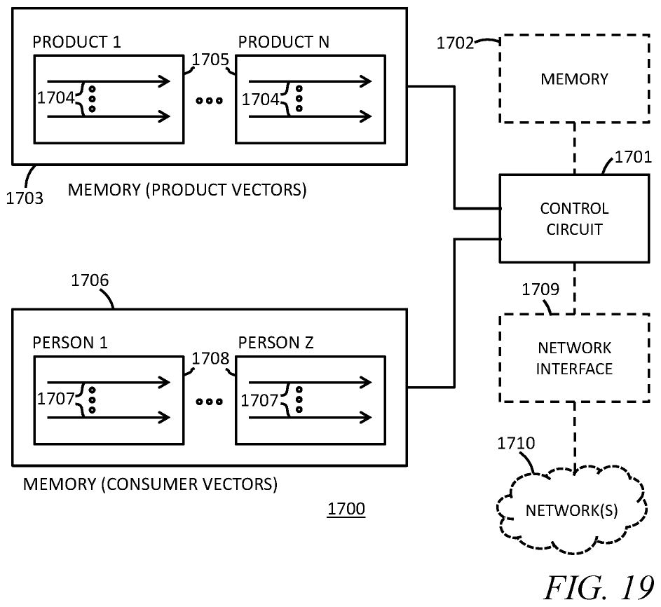

FIG. 19 presents an illustrative apparatus 1700 for conducting, containing, and utilizing the foregoing content and capabilities. In this particular example, the enabling apparatus 1700 includes a control circuit 1701. Being a “circuit,” the control circuit 1701 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1701 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1701 is configured (for example, by using corresponding programming as will be well understood by those skilled in the art) to carry out one or more of the steps, actions, and/or functions described herein.

By one optional approach the control circuit 1701 operably couples to a memory 1702. This memory 1702 may be integral to the control circuit 1701 or can be physically discrete (in whole or in part) from the control circuit 1701 as desired. This memory 1702 can also be local with respect to the control circuit 1701 (where, for example, both share a common circuit board, chassis, power supply, and/or housing) or can be partially or wholly remote with respect to the control circuit 1701 (where, for example, the memory 1702 is physically located in another facility, metropolitan area, or even country as compared to the control circuit 1701).

This memory 1702 can serve, for example, to non-transitorily store the computer instructions that, when executed by the control circuit 1701, cause the control circuit 1701 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1702 or, as illustrated, in a separate memory 1703 are the vectorized characterizations 1704 for each of a plurality of products 1705 (represented here by a first product through an Nth product where “N” is an integer greater than “1”). In addition, and again either stored in this memory 1702 or, as illustrated, in a separate memory 1706 are the vectorized characterizations 1707 for each of a plurality of individual persons 1708 (represented here by a first person through a Zth person wherein “Z” is also an integer greater than “1”).

In this example the control circuit 1701 also operably couples to a network interface 1709. So configured the control circuit 1701 can communicate with other elements (both within the apparatus 1700 and external thereto) via the network interface 1709. Network interfaces, including both wireless and non-wireless platforms, are well understood in the art and require no particular elaboration here. This network interface 1709 can compatibly communicate via whatever network or networks 1710 may be appropriate to suit the particular needs of a given application setting. Both communication networks and network interfaces are well understood areas of prior art endeavor and therefore no further elaboration will be provided here in those regards for the sake of brevity.

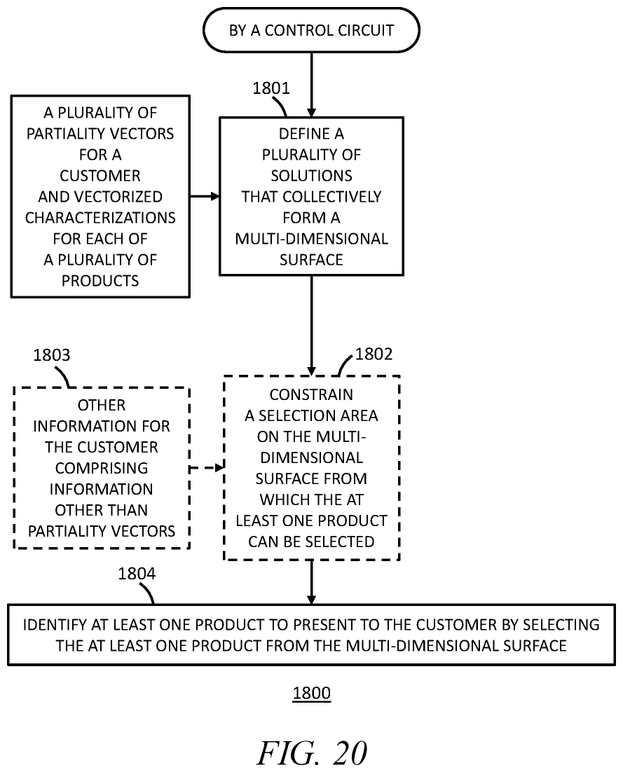

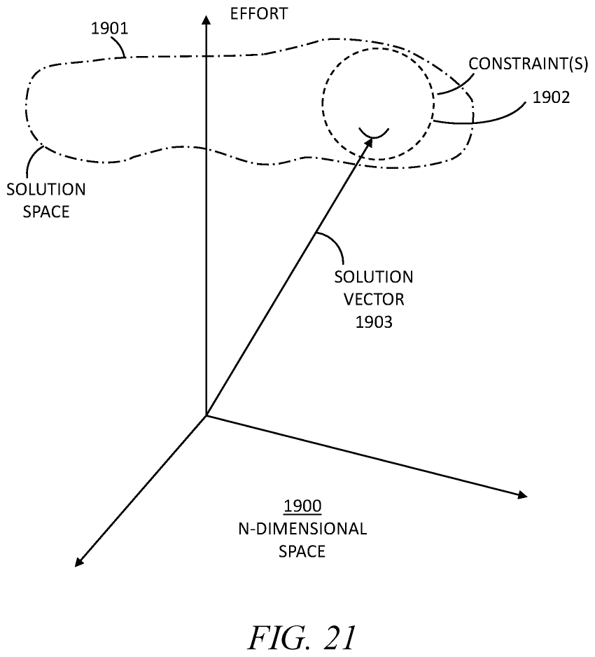

By one approach, and referring now to FIG. 20, the control circuit 1701 is configured to use the aforementioned partiality vectors 1707 and the vectorized product characterizations 1704 to define a plurality of solutions that collectively form a multidimensional surface (per block 1801). FIG. 21 provides an illustrative example in these regards. FIG. 21 represents an N-dimensional space 1900 and where the aforementioned information for a particular customer yielded a multi-dimensional surface denoted by reference numeral 1901. (The relevant value space is an N-dimensional space where the belief in the value of a particular ordering of one's life only acts on value propositions in that space as a function of a least-effort functional relationship.)

Generally speaking, this surface 1901 represents all possible solutions based upon the foregoing information. Accordingly, in a typical application setting this surface 1901 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 20 and 21, at optional block 1802 the control circuit 1701 can be configured to use information for the customer 1803 (other than the aforementioned partiality vectors 1707) to constrain a selection area 1902 on the multi-dimensional surface 1901 from which at least one product can be selected for this particular customer. By one approach, for example, the constraints can be selected such that the resultant selection area 1902 represents the best 95th percentile of the solution space. Other target sizes for the selection area 1902 are of course possible and may be useful in a given application setting.

The aforementioned other information 1803 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1902), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1804 the control circuit 1701 can then identify at least one product to present to the customer by selecting that product from the multi-dimensional surface 1901. In the example of FIG. 21, where constraints have been used to define a reduced selection area 1902, the control circuit 1701 is constrained to select that product from within that selection area 1902. For example, and in accordance with the description provided herein, the control circuit 1701 can select that product via solution vector 1903 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1701 may respond per these teachings to learning that the customer is planning a party that will include seven other invited individuals. The control circuit 1701 may therefore be looking to identify one or more particular beverages to present to the customer for consideration in those regards. The aforementioned partiality vectors 1707 and vectorized product characterizations 1304 can serve to define a corresponding multi-dimensional surface 1901 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1902 to beverages that contain no alcohol. As another example in these regards, the control circuit 1701 may have objective information that the party is to be held in a state park that prohibits alcohol and may therefore similarly constrain the available selection area 1902 to beverages that contain no alcohol.

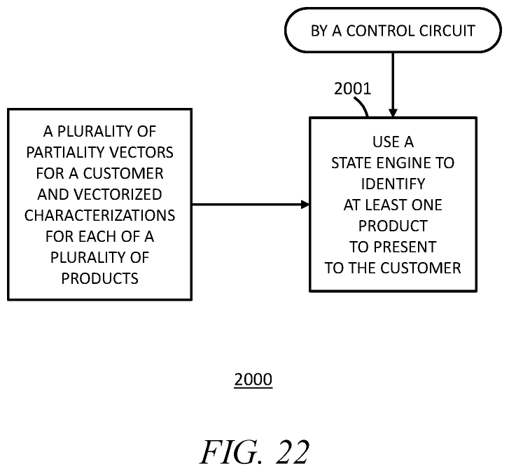

As described above, the aforementioned control circuit 1701 can utilize information including a plurality of partiality vectors for a particular customer along with vectorized product characterizations for each of a plurality of products to identify at least one product to present to a customer. By one approach 2000, and referring to FIG. 22, the control circuit 1701 can be configured as (or to use) a state engine to identify such a product (as indicated at block 2001). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

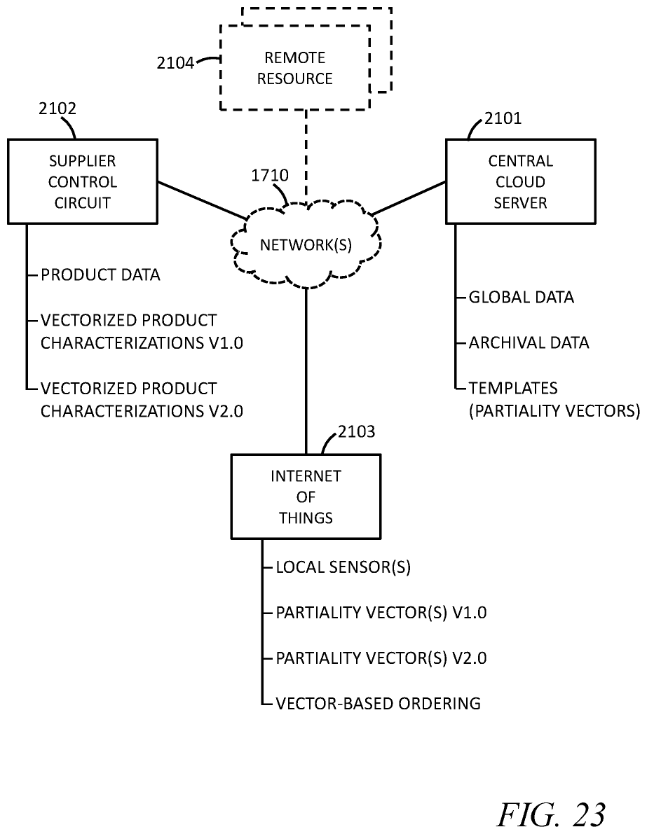

It will be appreciated that the apparatus 1700 described above can be viewed as a literal physical architecture or, if desired, as a logical construct. For example, these teachings can be enabled and operated in a highly centralized manner (as might be suggested when viewing that apparatus 1700 as a physical construct) or, conversely, can be enabled and operated in a highly decentralized manner. FIG. 23 provides an example as regards the latter.

In this illustrative example a central cloud server 2101, a supplier control circuit 2102, and the aforementioned Internet of Things 2103 communicate via the aforementioned network 1710.

The central cloud server 2101 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 2101 that store identical, overlapping, or wholly distinct content.)

The supplier control circuit 2102 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 23 by the expression “vectorized product characterizations V1.0”) for a given product as well as subsequent, updated vectorized product characterizations (denoted in FIG. 23 by the expression “vectorized product characterizations V2.0”) for the same product. Such modifications may have been made by the supplier control circuit 2102 itself or may have been made in conjunction with or wholly by an external resource as desired.

The Internet of Things 2103 can comprise any of a variety of devices and components that may include local sensors that can provide information regarding a corresponding user's circumstances, behaviors, and reactions back to, for example, the aforementioned central cloud server 2101 and the supplier control circuit 2102 to facilitate the development of corresponding partiality vectors for that corresponding user. Again, however, these teachings will also support a decentralized approach. In many cases devices that are fairly considered to be members of the Internet of Things 2103 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 2102 and use that information in conjunction with local partiality vector information to facilitate the vector-based ordering.

Also, if desired, the smart phone in this example can itself modify and update partiality vectors for the corresponding user. To illustrate this idea in FIG. 23, this device can utilize, for example, information gained at least in part from local sensors to update a locally-stored partiality vector (represented in FIG. 23 by the expression “partiality vector V1.0”) to obtain an updated locally-stored partiality vector (represented in FIG. 23 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 2104. These remote resources 2104 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth. To the extent any of these examples involve evaluation of data particular to given individuals, in some embodiments, as may be required under certain privacy laws or regulations, use of these remote resources may first need to be authorized by the individual, such as by the user opting in or agreeing to such use.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,089 filed Mar. 14, 2017; 62/471,804 filed Mar. 15, 2017; 62/471,830 filed Mar. 15, 2017; 62/479,106 filed Mar. 30, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801 filed Apr. 18, 2017; 62/491,455 filed Apr. 28, 2018; 62/502,870 filed May 8, 2017; 62/510,322 filed May 24, 2017; 62/510,317 filed May 24, 2017; Ser. No. 15/606,602 filed May 26, 2017; 62/511,559 filed May 26, 2017; 62/513,490 filed Jun. 1, 2017; 62/515,675 filed Jun. 6, 2018; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; 62/559,128 filed Sep. 15, 2017; Ser. No. 15/783,787 filed Oct. 13, 2017; Ser. No. 15/783,929 filed Oct. 13, 2017; Ser. No. 15/783,825 filed Oct. 13, 2017; Ser. No. 15/783,551 filed Oct. 13, 2017; Ser. No. 15/783,645 filed Oct. 13, 2017; Ser. No. 15/782,555 filed Oct. 13, 2017; 62/571,867 filed Oct. 13, 2017; Ser. No. 15/783,668 filed Oct. 13, 2017; Ser. No. 15/783,960 filed Oct. 13, 2017; Ser. No. 15/782,559 filed Oct. 13, 2017; Ser. No. 15/921,540 filed Mar. 14, 2018; Ser. No. 15/939,788 filed Mar. 29, 2018; Ser. No. 15/947,380 filed Apr. 6, 2018; Ser. No. 15/952,494 filed Apr. 13, 2018; and Ser. No. 15/953,113 filed Apr. 13, 2018.

What is claimed is:

1. A system for presenting merchandise to customers at a shopping facility, the system comprising:
a shopping facility hosting an educational, entertainment, or experiential event and including a predetermined hosting area for customers attending the event;
a plurality of merchandise items related to the educational, entertainment, or experiential event;
an automated storage and retrieval system comprising:
a merchandise holding area at the shopping facility for holding the plurality of merchandise items related to the educational, entertainment, or experiential event;
at least one robot configured to move between the merchandise holding area and the predetermined hosting area;
customer characteristics or preferences of at least one of the customers attending the educational, entertainment, or experiential event;
a control circuit operatively coupled to the automated storage and retrieval system, the control circuit configured to:
identify and select the plurality of merchandise items related to the educational, entertainment, or experiential event, the plurality of merchandise items constituting a first subset of all merchandise items available for purchase;
instruct stocking of the merchandise holding area with the first subset of merchandise items related to the educational, entertainment, or experiential event;
identify and select a second subset of merchandise items from the first subset of merchandise items based on the customer characteristics or preferences; and
instruct the at least one robot to gather the second subset of merchandise items from the merchandise holding area and to deliver the second subset to the predetermined hosting area.

2. The system of claim 1, wherein the educational, entertainment, or experiential event comprises one or more of events relating to cooking demonstrations, sporting related events, camping, fishing, home improvement projects, art, music, and clothing fashion.

3. The system of claim 1, wherein the predetermined hosting area provides access to one or more of games, video monitors, entertainment and leisure activities, food and beverages, relaxing environmental ambience, and chairs and other lounge items to facilitate the comfort of customers.

4. The system of claim 1, wherein the merchandise holding area comprises:
one or more rooms with a plurality of compartments of various sizes with each compartment large enough to hold to one or more of the first subset of merchandise items, each compartment being configured to be accessible by the at least one robot to retrieve merchandise items therein.

5. The system of claim 1, wherein the at least one robot is an autonomous ground vehicle (AGV) comprising:
a locomotion system configured to facilitate movement of the AGV between the predetermined hosting area and the merchandise holding area;
at least one obstacle detection sensor configured to detect obstacles in a direction of travel of the AGV;
a navigational system configured to guide movement of the AGV and avoid obstacles;
a merchandise retrieval mechanism configured to retrieve the second subset of merchandise items from the merchandise holding area;
an AGV control circuit operatively coupled to the locomotion system, the at least one obstacle detection sensor, the navigational system, and the merchandise retrieval mechanism, the AGV control circuit configured to operate and move the AGV and to retrieve and deliver merchandise.

6. The system of claim 1, further comprising:
a customer database containing at least one of demographic information of the at least one customer, shopping history of the at least one customer, and responses to a questionnaire or a shopping list completed by the at least one customer;
wherein the customer characteristics or preferences are at least one of demographic information, the shopping history, and the responses to the questionnaire or the shopping list.

7. The system of claim 1, further comprising:
a customer database including partiality information for the customer in the form of a plurality of partiality vectors wherein each of the partiality vectors has at least one of a magnitude and an angle that corresponds to a magnitude for the customer associated with that partiality; and
a product database including candidate item vectorized characterizations for each candidate item in the first subset of merchandise items, wherein each of the vectorized characterizations indicates a measure regarding an extent to which a corresponding one of the candidate items accords with a corresponding one of the plurality of partiality vectors.

8. The system of claim 7,
wherein each of the customer partiality vectors has at least one of a magnitude and an angle that corresponds to a magnitude of the corresponding customer's belief in an amount of good that comes from an order associated with that partiality.

9. The system of claim 7, wherein the control circuit is further configured to:
use the partiality vectors and the candidate item vectorized characterizations to identify the second subset of merchandise items that accord with a given customer's own partialities.

10. The system of claim 1, wherein the control circuit is further configured to schedule the educational, entertainment, or experiential event at the shopping facility.

11. The system of claim 1, further comprising a communication interface at the predetermined hosting area configured to transmit input from the at least one customer regarding customer characteristics or preferences.

12. A method for presenting merchandise to customers at a shopping facility, the method comprising:
hosting an educational, entertainment, or experiential event at a shopping facility and including a predetermined hosting area for customers attending the event;
providing a plurality of merchandise items related to the educational, entertainment, or experiential event;
holding the plurality of merchandise items related to the educational, entertainment, or experiential event in a merchandise holding area;
by at least one robot, moving between the merchandise holding area and the predetermined hosting area;
by a control circuit:
identifying and selecting the plurality of merchandise items related to the educational, entertainment, or experiential event, the plurality of merchandise items constituting a first subset of all merchandise items available for purchase;
instructing stocking of the merchandise holding area with the first subset of merchandise items related to the educational, entertainment, or experiential event;
identifying and selecting a second subset of merchandise items from the first subset of merchandise items based on customer characteristics or preferences of at least one of the customers attending the educational, entertainment, or experiential event; and
instructing the at least one robot to gather the second subset of merchandise items from the merchandise holding area and to deliver the second subset to the predetermined hosting area.

13. The method of claim 12, wherein the merchandise holding area comprises:
one or more rooms with a plurality of compartments of various sizes with each compartment large enough to hold to one or more of the first subset of merchandise items, each compartment being configured to be accessible by the at least one robot to retrieve merchandise items therein.

14. The method of claim 12, further comprising, by the at least one robot:
facilitating movement of the at least one robot between the predetermined hosting area and the merchandise holding area;
detecting obstacles in a direction of travel of the at least one robot;
guiding movement of the at least one robot and avoiding obstacles; and
retrieving the second subset of merchandise items from the merchandise holding area and delivering the second subset to the predetermined hosting area.

15. The method of claim 12, wherein:
a customer database contains at least one of demographic information of the at least one customer, shopping history of the at least one customer, responses to a questionnaire, or a shopping list completed by the at least one customer; and
the customer characteristics or preferences are at least one of demographic information, the shopping history, the responses to the questionnaire, or the shopping list.

16. The method of claim 12, further comprising:
storing in a customer database partiality information for the customer in the form of a plurality of partiality vectors wherein each of the partiality vectors has at least one of a magnitude and an angle that corresponds to a magnitude for the customer associated with that partiality; and
storing in a product database candidate item vectorized characterizations for each candidate item in the first subset of merchandise items, wherein each of the vectorized characterizations indicates a measure regarding an extent to which a corresponding one of the candidate items accords with a corresponding one of the plurality of partiality vectors.

17. The method of claim 16,
wherein each of the customer partiality vectors has at least one of a magnitude and an angle that corresponds to a magnitude of the corresponding customer's belief in an amount of good that comes from an order associated with that partiality.

18. The method of claim 16, further comprising, by the control circuit:
using the partiality vectors and the candidate item vectorized characterizations to identify the second subset of merchandise items that accord with a given customer's own partialities.

19. The method of claim 12, further comprising, by the control circuit: scheduling the educational, entertainment, or experiential event at the shopping facility.

20. The method of claim 12, further comprising, by a communication interface at the predetermined hosting area: transmitting input from the at least one customer regarding customer characteristics or preferences.
